(19) United States
(12) Patent Application Publication
(10) Pub. No.: US 2009/0029652 A1
(43) Pub. Date: Jan. 29, 2009

(54) ADJUSTING POWER CONSUMPTION OF MOBILE COMMUNICATION DEVICES BASED ON RECEIVED SIGNAL QUALITY

(76) Inventors: Kai Xie, Milpitas, CA (US); Ted Hsiung, Saratoga, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/828,180

(22) Filed: Jul. 25, 2007

(51) Int. Cl. H04B 7/005

(52) U.S. Cl. 455/69

(57) ABSTRACT

To make more efficient use of power resources, a mobile device adjusts the power necessary for receiving and/or transmitting data in response to signal quality. As the quality of received signals change, the device alters the power used to transmit and/or receive signals. When signal quality is poor, more power is used to receive the signal to maintain device functionality. When signal quality is strong, less power can be used while still maintaining device performance. This preserves device functionality while allowing the device to conserve power when possible.

### BACKGROUND

1. Field of Art

The present invention generally relates to the field of power management in mobile communication devices, and more specifically, to adjusting power consumption based on received signal quality.

2. Description of the Related Art

Mobile communication devices such as mobile phones, smartphones, personal digital assistants and handheld computers are becoming increasingly more powerful and functional devices while their size decreases. Many mobile communication devices are now multifunction devices, able to be controlled with one hand, with multiple device roles including: personal digital assistant (PDA), cellular phone, portable media player, voice recorder, video recorder, global positioning system (GPS), camera, and/or electronic file storage. Similarly, portable computer functionality has continued to increase while the computers become thinner and lighter. This combination of increased functionality and reduced size has made mobile device use more prevalent.

Additionally, advancements in both wireless Internet coverage and wireless network capabilities have made a broad range of data, such as electronic files, image files, audio files and video files, more accessible to mobile communication devices, including portable computers. Network improvements have also allowed electronic data to be accessed from virtually all locations. Thus, the improvements in both wireless network access and portable device design and functionality has increased the use of portable communication devices for data modification, event scheduling and other common tasks.

However the increased functionality and reduced size of mobile devices has made power consumption an increasingly important characteristic of mobile devices. Particularly, the decreased size of mobile devices has limited the space available for batteries or other power sources while the increased functionality of mobile devices has increased the overall power required for the devices. Thus, it is increasingly important for portable devices to efficiently use their limited power supplies. In particular, improved power management systems can increase the operational time of mobile communication devices without reducing their functionality or increasing their size to accommodate larger power supplies.

Therefore, there is a need for efficient power management techniques for mobile communication devices.

### SUMMARY

Various embodiments of the invention allow the power used by a mobile communication device to be adjusted based on the quality of communication signals received wirelessly by the mobile device. Since power is consumed when data is transmitted and/or received by a mobile device, adjusting the power required for transmission or reception decreases the overall power consumed by the device. To achieve this power adjustment, the mobile communication device adjusts the power used for transmission or reception based on the signal quality of the received signal. In this way, less power is used when a received signal has high quality as less processing is necessary to make the received signal useable.

In one implementation, a signal is received and a signal quality, such as a signal-to-noise ratio or a bit error rate, of the received signal is computed. The computed signal quality is then used to adjust the power provided for reception and/or transmission. In one approach, the signal quality is compared with a threshold value and the power is adjusted depending on whether the signal quality is above or below the threshold value.

In one implementation, a mobile communication device includes a receiving signal path, a power supply subsystem and a signal characterization module. The power supply subsystem provides power to the receiving signal path and/or to a transmitting signal path. The signal characterization module is coupled between the receiving signal path and the power supply subsystem. Based on a signal quality of a wireless communication signal received by the receiving signal path, the signal characterization module adjusts the power provided by the power supply subsystem to the receiving signal path and/or to the transmitting signal path. For example, for received signals with a higher signal-to-noise ratio, the power supply subsystem may provide less power to an analog-to-digital converter in the receiving signal path. This may result in a lower resolution analog-to-digital conversion, but which resolution is still sufficient given the higher signal-to-noise ratio of the incoming signal.

Other aspects of the invention include devices that implement power saving techniques such as those described above, components for these devices, and systems using these devices or techniques. Further aspects include methods and processes corresponding to all of the foregoing.

### BRIEF DESCRIPTION OF DRAWINGS

The disclosed embodiments have other advantages and features which will be more readily apparent from the following detailed description and the appended claims, when taken in conjunction with the accompanying drawings, in which:

FIG. 1 is a block diagram of a data communication network suitable for use with the invention.

FIG. 2 is a block diagram of a transceiver according to one embodiment of the invention.

FIG. 3 is a flowchart of adjusting power consumption according to one embodiment of the invention.

FIG. 4 is a flowchart of a method for computing signal quality according to one embodiment of the invention.

FIG. 5 is a block diagram of a baseband processor according to another embodiment of the invention.

### DETAILED DESCRIPTION

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention. It is noted that wherever practicable similar or like reference numbers may be used in the figures and may indicate similar or like functionality.

Generally, the following examples allow the power used to receive and/or transmit data to be adjusted in response to the quality of a received data signal. When the received signal is high-quality, the power used to receive the signal is reduced. For example, in one implementation, when the received signal is converted from an analog signal to a digital signal, the number of bits comprising the digital signal is decreased when the received signal quality is high. Because the received signal quality is high, this resolution reduction does not detract from device performance but does reduce device power consumption. Similarly, when the received signal quality is low, the power used to receive the signal is increased. For example, when the receive signal is converted from an analog signal to a digital signal, the number of bits comprising the digital signal is increased. Although this resolution increase requires more power, it maintains device functionality. Because the power used varies with signal quality, the device is configured to only consume as much power is necessary to maintain its performance level (e.g., a specific bit error rate). Corresponding power adjustments can also be made for data transmission.

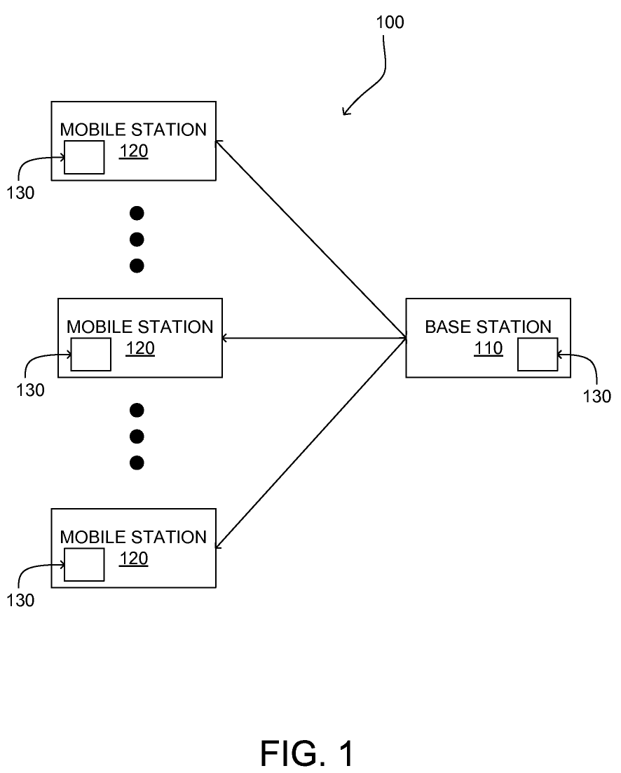

FIG. 1 shows a data communication network 100 suitable for use with the invention. The data communication network 100 includes a base station 110 and one or more mobile stations 120 (i.e., mobile communication devices). The base station 110 and mobile stations 120 include transceivers 130 for wirelessly transmitting and receiving data between the devices. In some applications, the data communication network 100 is a wireless network compliant with the IEEE 802.16 standard, the IEE 802.11 standard or any other time division duplexing (TDD) format. For convenience, FIG. 1 shows transceivers 130 but devices 110 and 120 could be configured with only transmitters or only receivers if bidirectional communication is not required.

The data communication network 100 typically uses symbols to represent data to be transmitted and uses multicarrier modulation to transmit the symbols. For example, the data communication network 100 could transmit data symbols using orthogonal frequency-division multiplexing (OFDM), binary phase-shift keying (BPSK), or other modulation methods. Multicarrier modulation techniques, such as ODFM divide the data stream to be transmitted into several parallel data streams, each containing less data than the original data stream. The available frequency spectrum is then divided into several sub-channels and each reduced data stream is transmitted by using a modulation scheme such as BPSK, phase-shift-keying (PSK), or quadrature amplitude modulation (QAM) to modulate each sub-channel.

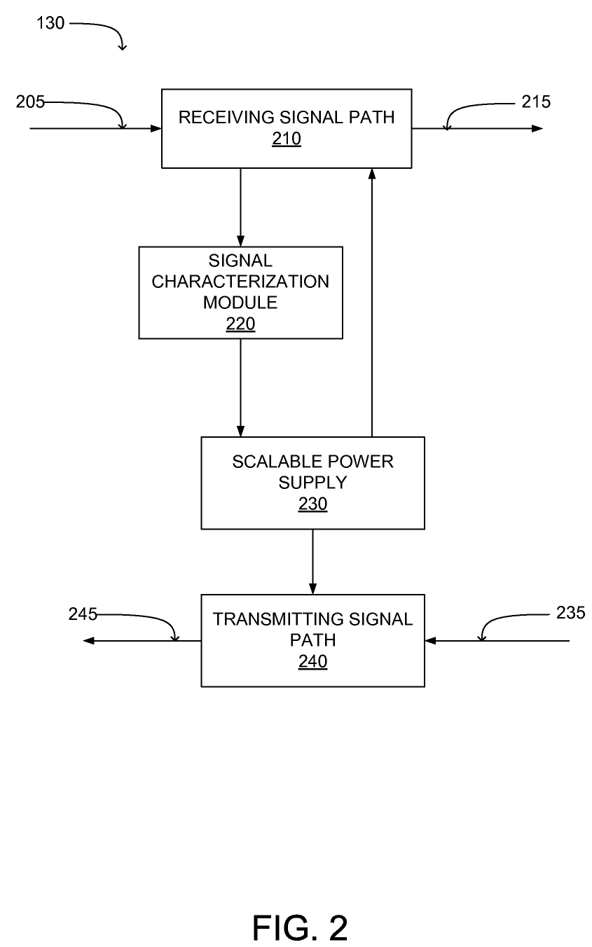

The base station 110 and mobile station 120 include transceivers 130 for transmitting and receiving wireless communications signals that contain these data symbols. The transceiver 130 transmits wireless communication signals and receives wireless communication signals to be processed from other devices. In certain applications, the transceiver 130 includes an antenna capable of transmitting and receiving wireless signals, such as those compliant with the IEEE 802.16 standard, IEEE 802.11a/b/g standard or other wireless communication formats. However, the transceiver 130 can be any device capable of wirelessly transmitting and receiving signals. When transceiver 130 transmits or receives data, it draws power from the corresponding base station 110 or mobile station 120. By varying this power consumption responsive to signal quality, the base station 110 or mobile station 120 is able to operate longer without requiring a larger power supply. A more detailed description of the structure of the transceiver 130 is provided in conjunction with FIG. 2.

FIG. 2 shows a variable-power consumption transceiver 130 in accordance with an embodiment of the invention. In this example, the transceiver 130 includes a receiving signal path 210, a signal characterization module 220, a scalable power supply subsystem 230 and a transmitting signal path 240. The receiving signal path 210 receives a wireless communication signal 205 and processes the received signal to recover the data encoded on the signal. In the case of RF communications, the complete receiving signal path 210 might include an RF antenna to provide gain and/or directionality, an RF front end to convert the received RF signal to baseband form, and a baseband processor to recover the encoded data. The baseband processor could include an analog-to-digital converter (ADC) which converts baseband analog signals to digital signals, and additional data processing elements (such as DSPs, processors and associated clocks and storage). The receiving signal path 210 can use various designs to implement the ADC, such as direct conversion, delta-sigma, pipeline, delta-encoded or other suitable converter architectures.

The signal characterization module 220 is coupled to the receiving signal path 210 and processes the received signal to determine the quality of the received wireless communication signal 205. The signal characterization module 220 may use the raw wireless communication signal 205 directly or may use the received signal after it has been partially or fully processed by the receiving signal path 210.

The signal characterization module 220 can be implemented in many ways. For example, it may be structured as a software process and/or a firmware application. The software and/or firmware can be structured to operate on a general purpose microprocessor or controller, a specialized processor or controller, a field programmable gate array (FPGA) or an application specific integrated circuit (ASIC) or a combination thereof In addition to processing capability, the signal characterization module 220 typically also includes a memory module (or other storage) that stores instructions and/or data for execution or other use by a processor. In some implementations, the memory module stores data describing the signal strength of the received wireless communication signal 205 and data describing the noise affecting the network 100. The signal characterization module 220 can be implemented as part of the scalable power supply subsystem 230.

The scalable power supply subsystem 230 provides power to the receiving signal path 210 and/or to the transmitting signal path 240. The amount of power provided is adjusted by the signal characterization module 220, based on the signal quality of the wireless communication signal 205. For example, when signal quality is high, power consumption is reduced by reducing the number of signal processing operations performed. In one implementation, the scalable power supply subsystem 230 is a voltage source capable of altering the voltage output in response to control signals from the signal characterization module 220. In another approach, the scalable power supply subsystem 230 is a voltage regulator module or other device capable of dynamically adjusting the voltage output. In many mobile communication devices, for example in many handheld devices, the power supply subsystem 230 is battery-powered.

In some cases, the transceiver 130 further includes a transmitting signal path 240 which receives a data signal 235 for transmission to another device as wireless communication signal 245. The transmitting signal path 240 often is the reverse of the receiving signal path 210. For example, it might include a baseband process (with data processing elements and digital-to-analog converter), followed by an RF front end and antenna. The transmitting signal path 240 can use various designs to implement the digital-to-analog converter, such as pulse width modulation, delta-sigma, R-2R ladder, segmented or other suitable converter architectures. The signal characterization module 220 may also (or alternately) adjust the power provided by power supply subsystem 230 to transmitting signal path 240 based on the received signal quality.

For convenience, the terms “receiving signal path” and “transmitting signal path” will be used to refer both to the entire signal paths and to portions of the entire signal path. For example, the term “receiving signal path” includes the entire path from antenna to RF front end to ADC to subsequent processing, but it also includes just the ADC alone or just the subsequent processing alone or just the ADC in combination with the subsequent processing.

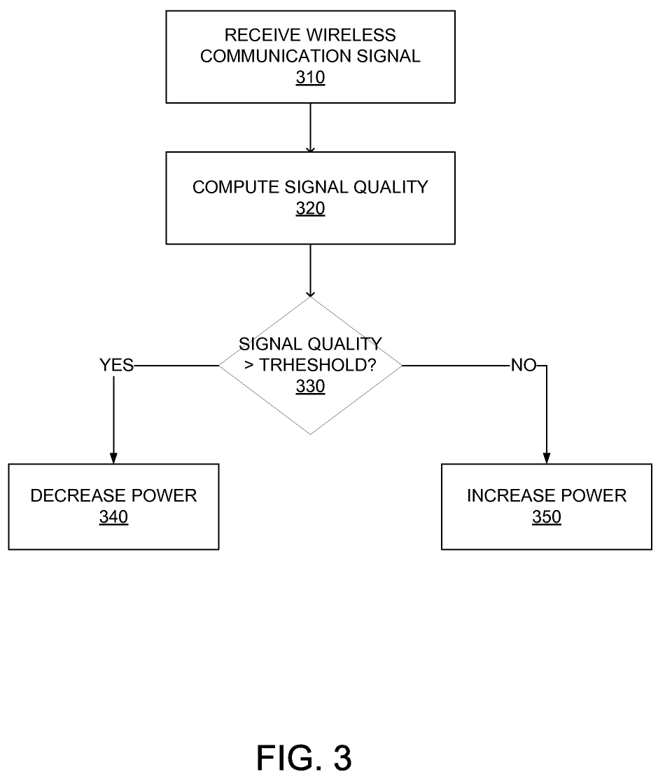

FIG. 3 shows a method for adjusting power responsive to signal quality according to an embodiment of the invention. In the example of FIG. 3, the receiving signal path 210 receives 310 a wireless communication signal (which could be either the directly transmitted signal 205 or a signal derived from it). The signal quality of the received signal is then computed 320.

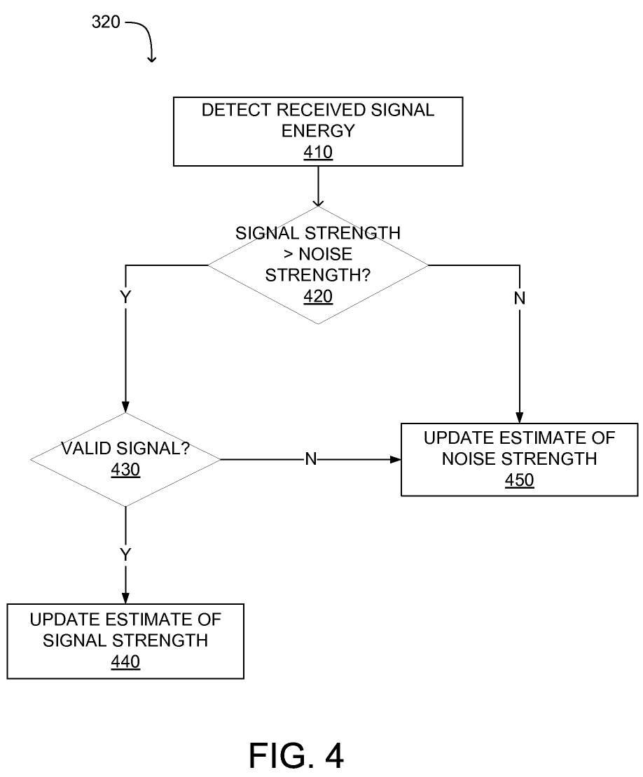

A common measure of signal quality is signal-to-noise ratio. In one approach, a signal strength is estimated based on reception of the wireless communication signal 205. The noise strength is estimated based on reception without a wireless communication signal 205. The signal-to-noise ratio is determined by taking the ratio of the estimated signal strength and estimated noise strength. Alternatively, the signal quality computation 320 can be a bit-error-rate estimate of the received signal, a signal-plus-noise-plus-distortion to noise-plus-distortion (SINAD) ratio or other metric indicating signal parameters relative to noise parameters. The noise energy can be a fixed value or can be dynamically adjusted as network 100 conditions change. In one implementation, during the signal quality computation 320, a new value for noise energy is also computed and stored for subsequent computations 320. FIG. 4, described below, illustrates an example algorithm for computing 320 signal quality. However, other algorithms, such as computing a ratio of received signal energy to noise energy, can be used to determine 320 the received signal quality.

In step 330 of FIG. 3, the computed signal quality (e.g., SNR) is compared to a threshold value. If the computed signal quality is high (e.g., when it exceeds a threshold value), the power provided by the scalable power supply subsystem 230 is decreased 340. Conversely, if the computed signal quality is low (e.g., when it falls below a threshold value), the power provided by the scalable power supply subsystem 230 is increased 340.

FIG. 4 shows an algorithm for computing 320 signal quality according to an embodiment of the invention. The receiving signal path 210 generates outputs. If a communication signal is present, then the output represents signal. If no communication signal is present, then the output represents noise. In this way, signal strength and noise strength can be estimated.

In the approach of FIG. 4, the signal characterization module 220 stores estimates of signal strength and noise strength, which are updated as follows. The strength of a signal received by the receiving signal path 210 is detected 410. It is then determined 420 whether the detected signal strength exceeds the current estimate of the noise strength. The initial estimate of the noise strength can be preset to a reference value. If the received signal strength does not exceed the current estimate of the noise strength, then the received signal is assumed to be noise only (no valid signal) and the estimate of noise strength is updated 450.

If the detected signal strength exceeds the current estimate of noise strength, then either the noise strength has increased or the detected signal includes a valid signal. It is then determined 430 whether the detected signal is a valid signal (i.e., conforms to the protocol for wireless communication between base station and mobile station). This typically can be achieved by the data processing section of the receiving signal path 210.

If the received signal is not a valid signal, then it is assumed to be noise and the stored noise strength is updated 450 to reflect the higher noise level. Alternatively, if the received signal is a valid signal, then the current estimate of the signal strength is updated 440. In one approach, the signal strength is updated 440 by subtracting the estimated noise strength from the strength of the detected signal and using the resulting value as the estimate of the signal strength. This value can also be used to determine 330 whether the provided power should be increased or decreased. Alternatively, the signal quality may be updated 440 by storing the strength of the received valid signal, by calculating a parameter based on the received valid signal, or by any other method deriving a representation of signal quality from detected signal strength.

FIG. 5 is a block diagram of a baseband processor according to another embodiment of the invention. In this example, the mobile stations 120 and base station 110 communicate via RF wireless links. In various applications, the RF wireless links are compliant with the IEEE 802.16 standard, the IEE 802.11 standard or any other time division duplexing (TDD) format. The mobile stations typically have transceivers that include an RF antenna, an RF front-end subsystem, a baseband processor subsystem and a media access control (MAC) subsystem. FIG. 5 shows only the baseband processor subsystem, which interfaces on the lefthand side to the RF front-end subsystem and interfaces on the righthand side to the MAC subsystem. In one implementation, the baseband processor is implemented on a single chip.

In this example, the receiving signal path 210 includes an analog-to-digital converter 512, a sample rate converter 514 and a receiving datapath 516 (which implements additional data processing, such as decoding and error checking). The transmitting signal path 240 includes a transmitting datapath 546, a sample rate converter 544 and a digital-to-analog converter 542. The power supply subsystem 230 is a scalable voltage supply. The signal characterization module 220 characterizes SNR for the received signal.

The SNR module 220 adjusts the power provided by supply 230 according to the SNR of the received signal. More specifically, the power adjustment changes the effective resolution of the ADC 512 and/or the DAC 542. In one approach, lower signal quality (i.e., lower SNR) results in a higher voltage supplied to the ADC 512, thus increasing its resolution. For example, when the signal quality falls below a specified threshold, the ADC resolution might increase from a minimum of 6 bits to a maximum of 10 bits. In one implementation, the ADC 512 always generates 10 bits for the sample rate converter 514 but, when the effective resolution is 6 bits, then four of the 10 bits are always 0. In this case, the circuitry in the remainder of the receiving signal path 210 that would normally process these four bits (which are now all 0) may also be switched off (or to a power saving mode). Because reducing ADC resolution decreases the power required to operate the transmitting signal path 210, power consumption is decreased but device functionality is preserved because the received signal has sufficient strength to offset the lower resolution of the ADC 512. For example, reducing the resolution of a 10-bit ADC 512 or a 10-bit DAC 542 by one bit results in a 10%-20% power savings by reducing the computational complexity. Alternatively, a clock rate for data operations (e.g., “add,” “multiply,” “read,” etc.) is modified responsive to signal quality.

For example, in a system designed so that a quadrature phase shift keying (QPSK) signal with a signal-to-noise ratio (SNR) of 10 dB can be correctly demodulated and decoded, ADC 512 or DAC 542 resolution can be reduced as long as the quantization noise does not degrade SNR below 10 dB. Hence, in the above-described example, if a signal having an SNR of 50 dB is received, the ADC 512 and/or DAC 542 resolution is reduced. Although the reduction in resolution increases the quantization noise in the system, as long as the quantization noise does not degrade signal SNR below 10 dB, the signal can be correctly detected and demodulated.

In one configuration, a similar process is used to increase or decrease the resolution of the DAC 542 to adjust the wireless communication signal transmitted by the transceiver, resulting a lower-power RF signal. For example, a 10 bit DAC 542 uses a voltage range of 0-1.5V while a 10-bit DAC where the two most significant bits are 0, effectively an 8-bit DAC 542, uses a voltage range of 0-0.5V. Hence, when multiplied by the same gain value, the 8-bit DAC 542 output results in a reduced-power RF signal.

Power adjustment can occur at various stages of operation, for example during initial handshake between base station and mobile station, while idling (e.g., if a cell phone is on but not actively being used) or during active use (i.e., during the period when the mobile communications device is either receiving or transmitting wirelessly to the base station).

As used herein, “coupled” is intended to mean both coupled directly (without intervening elements) and coupled indirectly (with intervening elements). Upon reading this disclosure, those of skill in the art will appreciate still additional alternative structural and functional designs for a system and a method for adjusting power consumption in response to variations in signal quality through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A mobile communication device with automatic adjustment of power consumption based on signal quality, comprising:
a receiving signal path for receiving a wireless communication signal;
a power supply subsystem for supplying power to the receiving signal path and/or to a transmitting signal path; and
a signal characterization module coupled between the receiving signal path and the power supply subsystem, for adjusting power provided by the power supply subsystem to at least one of the signal paths in response to a signal quality of the received signal.

2. The mobile communication device of claim 1, wherein the power supply subsystem decreases the power provided if the signal quality exceeds a threshold value and increases the power provided if the signal quality is below the threshold value.

3. The mobile communication device of claim 1, further comprising:
a transmitting signal path, wherein the power supply subsystem adjusts power provided to the transmitting signal path.

4. The mobile communication device of claim 3, wherein the transmitting signal path includes a digital-to-analog converter and the power supply subsystem adjusts power provided to the digital-to-analog converter.

5. The mobile communication device of claim 3, wherein the power supply subsystem also adjusts power provided to the receiving signal path.

6. The mobile communication device of claim 1, wherein the power supply subsystem adjusts power provided to the receiving signal path.

7. The mobile communication device of claim 5, wherein the receiving signal path includes an analog-to-digital converter and the power supply subsystem adjusts power provided to the analog-to-digital converter.

8. The mobile communication device of claim 5, wherein the receiving signal path includes an analog-to-digital converter and the power supply subsystem reduces a resolution of the analog-to-digital converter.

9. The mobile communication device of claim 1, wherein the power supply subsystem adjusts power provided by the power supply subsystem to at least one of the signal paths in response to a signal-to-noise ratio of the received signal.

10. The mobile communication device of claim 9, wherein the power supply subsystem estimates a signal strength based on reception of a wireless communication signal, estimates a noise strength based on reception without a wireless communication signal, and determines the signal-to-noise ratio based on the estimated signal strength and the estimated noise strength.

11. The mobile communication device of claim 1, wherein the power supply subsystem adjusts the power provided by the power supply subsystem in order to maintain a maximum bit error rate given the signal quality of the received signal.

12. The mobile communication device of claim 1, wherein the power supply subsystem adjusts power provided by adjusting a voltage.

13. The mobile communication device of claim 1, wherein the power supply subsystem adjusts power provided by the power supply subsystem to the receiving signal path during a period when the receiving signal path is receiving a wireless communication signal.

14. The mobile communication device of claim 1, wherein the power supply subsystem adjusts power provided by the power supply subsystem to the transmitting signal path during a period when the transmitting signal path is transmitting a wireless communication signal.

15. The mobile communication device of claim 1, wherein the mobile communication device is a handheld device.

16. The mobile communication device of claim 1, wherein the mobile communication device is a handheld mobile phone.

17. The mobile communication device of claim 1, wherein the power supply subsystem is battery-powered.

18. The mobile communication device of claim 1, wherein the signal characterization module adjusts power provided by the power supply subsystem to a baseband processor portion of said signal path.

19. The mobile communication device of claim 1, wherein the wireless communication signal is a WiFi signal.

20. The mobile communication device of claim 1, wherein the wireless communication signal is a Wimax signal.

21. A method for automatically adjusting power consumption of a mobile communication device having a receiving signal path and/or to a transmitting signal path, comprising the steps of:
providing power to at least one of the signal paths;
receiving a wireless communication signal; and
adjusting the power provided to at least one of the signal paths in response to a signal quality of the received signal.

22. The method of claim 21, wherein adjusting the power provided comprises:
decreasing the power provided if the signal quality exceeds a threshold value; and
increasing the power provided if the signal quality is below the threshold value.

23. The method of claim 21, wherein adjusting the power provided to at least one of the signal paths comprises adjusting the power provided to the transmitting signal path in response to a signal quality of the received signal.

24. The method of claim 21, wherein adjusting the power provided to at least one of the signal paths comprises adjusting the power provided to the receiving signal path in response to a signal quality of the received signal.

25. The method of claim 24, wherein adjusting the power provided to the receiving signal path comprises adjusting the power provided to an analog-to-digital converter in the receiving signal path in response to a signal quality of the received signal.

26. The method of claim 24, wherein adjusting the power provided to the receiving signal path comprises adjusting a resolution of an analog-to-digital converter in the receiving signal path in response to a signal quality of the received signal.

27. The method of claim 21, wherein adjusting the power provided to at least one of the signal paths in response to a signal quality of the received signal comprises adjusting the power provided to at least one of the signal paths in response to a signal-to-noise ratio of the received signal.

28. The method of claim 27, wherein adjusting the power provided to at least one of the signal paths in response to a signal-to-noise ratio of the received signal comprises:
estimating a signal strength based on reception of a wireless communication signal;
estimating a noise strength based on reception without a wireless communication signal;
determining the signal-to-noise ratio based on the estimated signal strength and the estimated noise strength; and
adjusting the power provided to at least one of the signal paths in response to the determined signal-to-noise ratio.

29. The method of claim 20, wherein adjusting the power provided to at least one of the signal paths in response to a signal quality of the received signal comprises adjusting the power provided by the power supply subsystem in order to maintain a maximum bit error rate given the signal quality of the received signal.

30. The method of claim 21, wherein adjusting the power provided to at least one of the signal paths in response to a signal quality of the received signal comprises adjusting the power provided to the receiving signal path during a period when the receiving signal path is receiving a wireless communication signal.

31. The method of claim 21, wherein adjusting the power provided to at least one of the signal paths in response to a signal quality of the received signal comprises adjusting the power provided to a transmitting signal path during a period when the transmitting signal path is transmitting a wireless communication signal.

32. A baseband processor chip for a mobile communication device, comprising:
a receiving signal path for receiving wireless communication signals;
a transmitting signal path for transmitting wireless communication signals;
a power supply subsystem for supplying power to the receiving signal path and/or to the transmitting signal path; and
a signal characterization module coupled between the receiving signal path and the power supply subsystem, for adjusting power provided by the power supply subsystem to at least one of the signal paths in response to a signal quality of the received signal.
